(19) United States
(12) Patent Application Publication
(10) Pub. No.: US 2004/0099740 A1
(43) Pub. Date: May 27, 2004

(54) Merchandising components for authenticating products, and combinations and methods utilizing the same

(76) Inventors: Thomas J. Chresand, Shoreview, MN (US); Nathan M. Olson, New Richmond, WI (US); Richard C. Lindmark JR., Minneapolis, MN (US)

Correspondence Address: H.B. Fuller Company, Patent Department, 1200 Willow Lake Blvd., P.O. Box 64683, St. Paul, MN, 55164-0683, US

(21) Appl. No.: 10/304,161

(22) Filed: Nov. 25, 2002

(51) Int. Cl. G06K 7/10

(52) U.S. Cl. 235/457; 250/566

(57) ABSTRACT

The present invention relates to merchandising components for authenticating products, combinations that include the merchandising component and a product, methods of associating the merchandising component with a product, and methods of utilizing the merchandising component to authenticate a product. More particularly, the merchandising component includes an authentication component capable of producing a two-dimensional, human readable image upon irradiation with electromagnetic radiation. Advantageously, the image produced is unambiguous and capable of being verbally described in an objective manner. The image so produced can be compared with an authentication image, or verbal description thereof, known to be associated with the product in order to reach an authentication determination about the same.

### FIELD OF THE INVENTION

The present invention relates to merchandising components for authenticating products, combinations that include the merchandising component and a product, methods of associating an authentication component with a product, and methods of utilizing the inventive merchandising component to authenticate a product.

### BACKGROUND OF THE INVENTION

In many industries, it is at least desirable, if not necessary, to provide an authentication component in connection with a product to provide a means by which to determine whether or not the product is authentic or counterfeit. Such authentication components can vary in complexity and the level of training required to effectively utilize them. Generally speaking, this variance in complexity depends at least in part upon the number of products to be authenticated as well as the number of examinations that are desirably carried out during the life of the product.

For example, a signature on a fine art piece may act as highly complicated authentication component, requiring forensic analysis performed by a highly trained individual to determine the authenticity of the artwork. On the other hand, a hologram or watermark provided in connection with, e.g., software, may act as a simple authentication component, at least identifiable by the average untrained consumer. Field-readable components, including biological or chemical taggants, UV-readable inks or polarized images, are examples of authentication components of intermediate complexity in that they may require at least some training and/or equipment in order to utilize them to make an authentication determination.

Clearly, while the level of security that is provided by complex forensic authentication strategies may be desirable in many applications, the expense and time associated with implementing these strategies renders them suboptimal for use in others. Similarly, the level of expertise and/or expense associated with implementing and/or utilizing field-readable strategies may also be prohibitive in connection with some types of products. Finally, although watermarks, holograms, and the like are visible to consumers, thereby at least arguably providing the ancillary benefit of imbuing consumer confidence in the origin and/or quality of products so marked, these consumer-obvious authentication strategies typically do not allow a decisive analysis as to the authenticity of the product to be carried out by such mere observation. Such consumer-obvious components may also be susceptible to counterfeiting, since advanced or proprietary technology is typically not required to reproduce them.

It would thus be desirable to provide an authentication component, and method of using the same, that may be easily and decisively interpreted by a relatively untrained individual without expensive equipment. Desirably, the authentication component and method would provide substantially unambiguous authentication information so that a comparative standard would not be necessary in order to reach a decisive determination as to the authenticity of a product. Rather, to the extent that any assistance in interpretation was required, the same would desirably be provided easily via a simple objective verbal description. Such components and methods would also desirably be inexpensive to implement, at least relative to other strategies, and yet exhibit a high degree of counterfeit resistance so that the components and methods are capable of providing a high level of security to the product to which it is attached.

### SUMMARY OF THE INVENTION

The present invention features merchandising components for authenticating products, combinations comprising the merchandising component and a product, methods of associating an authentication component with a product, and methods of utilizing the inventive merchandising component to authenticate a product. More particularly, the present invention provides a merchandising component that includes an authentication component capable of producing a human readable, two-dimensional image upon irradiation with electromagnetic radiation, the image capable of being verbally described in an objective manner. As such, the image produced by the authentication component may be easily and objectively compared to an authentication image, or verbal description of an authentication image, associated with a product thereby rendering the merchandising component capable of authenticating the product. Substantially untrained individuals may thus easily utilize the merchandising components in order to authenticate any number of products.

In a first aspect then, the present invention provides a merchandising component for authenticating a product, where the merchandising component includes an authentication component capable of producing a human readable image upon irradiation with electromagnetic radiation. Advantageously, the image is two-dimensional and capable of being verbally described in an objective manner. The image so produced may thus be compared with an authentication image associated with the product, or verbal description of an authentication image, in order to determine the authenticity of the product. A plurality of authentication components can be provided and can be the same or different. In certain embodiments of the invention, the authentication component, or one of the plurality of authentication components, may desirably include a light shaping diffuser.

In another aspect, the present invention provides a combination that includes the merchandising component and a product. The product has an authentication image associated therewith that is objectively verbally describable. The merchandising component includes an authentication component as described above, and in certain embodiments, can advantageously further include packaging material at least partially surrounding the product or an item capable of being connected to the product.

In certain embodiments of the invention, the merchandising component may include a material that either by its nature, or the way that the merchandising component is manufactured or applied to a product, imparts further counterfeit resistance to the authentication component, tamper-resistance to the product, or both. For example, in those embodiments of the invention wherein the merchandising component includes a shrink-wrap film, the authentication component may be provided in connection therewith prior to shrinkage in a compensatory fashion so that when the film is ultimately shrunk about a product, an image with a verbally specified aspect ratio will be achieved. Also, the merchandising component can include a tamper-evident seal or band, so that efforts to remove the authentication component thereof would be evident and/or destroy the authentication component.

In such embodiments of the invention, the authentication component could be even more difficult to replicate than a similar authentication component not so provided, or could advantageously indicate any attempted tampering with the product. As such, and in yet another aspect, the present invention provides a method of associating a product with an authentication component. The method includes providing a product and selecting an image to identify the product as authentic. Desirably, the image is capable of being verbally described in an objective manner. A merchandising component that includes an authentication component capable of producing the image in a human readable fashion upon irradiation with electromagnetic radiation is provided and operatively disposed relative to the product.

Due at least in part to the ability of the inventive merchandising component to provide substantially unambiguous authentication information without the use of expensive or complicated equipment, little or no training is needed in order to utilize the component in order to authenticate a product. To the extent that any comparative standard could be deemed useful by the authenticator, the comparative standard can advantageously be provided via an objective verbal description. Further, the authentication component itself is difficult to copy, so that the merchandising component, and any product associated therewith, is substantially resistant to counterfeiting. As such, the present merchandising components may beneficially be utilized to authenticate any product.

As a result in a further aspect of the invention there is provided a method of authenticating a product. Generally speaking, the method includes the steps of operatively disposing a merchandising component relative to the product desirably authenticated. The merchandising component includes an authentication component capable of producing a human readable image upon irradiation with electromagnetic radiation. The authentication component is irradiated with electromagnetic radiation and the image produced is visually inspected in order to determine the authenticity of the product. The image produced may be viewed upon a surface separate from the product and/or merchandising component, or, may be viewed upon at least a portion of the product and merchandising component combination, or both. Optionally, the method may advantageously further include providing a verbal description of an authentication image associated with the product.

### BRIEF DESCRIPTION OF THE DRAWINGS

The accompanying drawings, which are incorporated in and constitute a part of this application, illustrate several aspects of the invention and, together with the description of the embodiments, serve to explain the principles of the invention. A brief description of the drawings is as follows:

FIG. 1 is a schematic, perspective view of an embodiment of a merchandising component that includes a hang tag;

FIG. 2 is a schematic, perspective view of the merchandising component of FIG. 1 illustrating a light source radiating light through the authentication component of the merchandising component of FIG. 1, and the objectively verbally describable image produced by the authentication component is a line;

FIG. 3 is a schematic, perspective view of an embodiment of a product and merchandising component combination that includes shrink wrap packaging;

FIG. 4 is a schematic, perspective view of the product and merchandising component combination of FIG. 3 receiving radiation from a light source and reflecting the radiation to provide an image objectively verbally describable as an ‘x’;

FIG. 5 is a schematic view of another embodiment of a product and merchandising component combination that includes an envelope and a tamper-evident seal;

FIG. 6 is a schematic view of the product and merchandising component combination of FIG. 5 receiving radiation from a light source and reflecting the radiation to provide an image objectively verbally describable as a circle;

FIG. 7 is a schematic view of the product and merchandising component combination of FIG. 5, in an open position, in which the tamper-evident seal has been broken, thereby exposing verbiage indicating that the combination may have been tampered with, or that the product may not be authentic;

FIG. 8 is a schematic view of another embodiment of a product and merchandising component combination further including a tamper-resistant label;

FIG. 9 is a schematic view of the product and merchandising combination of FIG. 8 receiving radiation from a light source and reflecting the radiation to provide an image objectively verbally describable as a triangle; and

FIG. 10 is a schematic view of the product and merchandising combination of FIG. 8, in which a portion of the tamper-resistant label has been removed.

### DETAILED DESCRIPTION OF EMBODIMENTS OF THE INVENTION

The embodiments of the present invention described below are not intended to be exhaustive or to limit the invention to the particular embodiments disclosed in the following detailed description. Rather, the embodiments are described so that others skilled in the art understand the principles and practices of the present invention.

The present invention relates to merchandising components for authenticating products, combinations that include the merchandising component and a product, methods of associating an authentication component with a product, and methods of utilizing the inventive merchandising component to authenticate a product. The merchandising component includes an authentication component capable of producing a human readable image upon illumination with electromagnetic radiation. The image produced is unambiguous and two dimensional, and as such, is capable of being verbally described in an objective manner. As such, the merchandising component is capable of being easily utilized to authenticate a product, without extensive training or the utilization of complicated or costly machinery, by simply comparing the human readable image with an authentication image or a verbal description of an authentication image associated with the product.

The authentication component may be any authentication component that is capable of producing, via transmission, reflection or a combination thereof, an unambiguous two-dimensional image upon irradiation with any form of electromagnetic radiation. The image produced is desirably readily discerned via visible inspection. Further, and due at least in part to the two-dimensional nature of the image, the image can be more easily verbally described in an objective manner relative to a three-dimensional image. As such, an individual untrained in authentication can compare the human readable image produced by the merchandising component with an authentication image associated with the product. Based upon this comparison, the individual can easily reach an authenticity determination with respect to the product.

The ease with which these two-dimensional images are described may be illustratively contrasted with the difficulty, if not impossibility, of verbally describing the three-dimensional image produced by a hologram. For example, although a dove hologram is now present on many credit cards, it would yet be difficult to objectively describe an authentic hologram verbally so that an untrained individual could determine the authenticity of a credit card bearing a similar hologram. Further, the image produced by many holograms can be dependent on the angle of incidence of the light beam, or the hologram. For this and other reasons, even if provided with an authentic version of the hologram with which to compare the card to be authenticated, many untrained individuals would be unable to reach a definite authentication determination.

In contrast, upon irradiation with electromagnetic radiation, the authentication component can produce a two-dimensional image via reflection, transmission or a combination thereof and the image can be verbally described in an objective manner. Such images include, e.g., an alphanumeric symbol, e.g., a number, letter, or a combination thereof, geometric shapes including, e.g., a circle, a line, multiple lines, multiple parallel lines, an ‘x’, a triangle, a square, a rectangle, an ellipse, a cone, and combinations thereof, a registered or unregistered trademark or service mark, or any other similarly objectively verbally describable pattern, shape or image, as well as combinations thereof. The electromagnetic radiation may be supplied via any suitable source including, e.g., a laser pointer.

If a combination of objectively verbally describable images is desired, the combination can be provided via a single authentication component or multiple authentication components. That is, a single authentication component can be holographically recorded so as to be capable of producing multiple objectively verbally describable images. Alternatively, multiple authentication components can be holographically recorded with multiple objectively verbally describable images and then employed in any combination in the merchandising component and can be associated with the merchandising component in a variety of arrangements including, e.g., randomly or in a pattern.

One authentication component capable of producing an unambiguous, two-dimensional, objectively verbally describable image is a light shaping diffuser. Such devices are well known, and are described along with methods for making the same in U.S. Pat. Nos. 3,534,386, 5,365,354, 5,609,939, and 6,158,245, the full disclosures of which are hereby incorporated by reference herein for all purposes. Advantageously, many light shaping diffuser structures are commercially available from Physical Optics Corporation (Torrence, Calif.).

Light shaping diffusers, also known as LSD's, are transparent or translucent structures incorporating random, disordered and non-planar light shaping structures on either an entrance surface or the interior of the LSD. LSD's are holographically recorded and reproduced by embossing or molding the structures onto polymeric films or other substrates. One of the differences between LSD's and other light homogenizing structures is that LSD's can be formed on very thin polymeric films. LSD's exhibit high transmission efficiencies, in some cases exceeding the transmission of the polymeric film itself. Superior transmission permits the formation of discernable images even when the incident light is from a low power source, e.g., a laser pointer.

Another unique property of LSD's is that the random nature of the surface structure renders the transmitted light pattern independent of the location of the incident beam. A conventional hologram, by contrast, will produce varied transmitted or reflected images depending on the position of the incident beam. Additionally, the randomized structure transmits a pattern that generally does not contain Moire and color diffraction patterns. Further, the randomized structure renders LSD's difficult to replicate.

Due to all of these advantageous properties, LSD's are preferred authentication components for use in the merchandising components and combinations that include the same. Merchandising components according to this preferred embodiment of the invention that include an LSD can advantageously be more difficult to counterfeit than devices that do not include an LSD. Nonetheless, in certain embodiments of the invention it may be desirable to provide a number of authentication components to further enhance the difficulty of replicating the merchandising component.

The plurality of authentication components can include the same or different authentication components, so long as one authentication component is capable of producing a two-dimensional unambiguous objectively verbally describable image. For example, the merchandising component may optionally further include any other authentication component, whether it be a forensic, field-readable or consumer-obvious authentication component. Authentication components analyzed via forensics include, e.g., handwriting, isotopic tracers, microtext, digital watermarking, and combinations thereof. Field-readable authentication components include, e.g., chemical and biological laggants, UV sensitive inks, radiofrequency identification (RFID) tags, magnetic stripes, and combinations thereof. Examples of consumer-obvious authentication components include holograms, watermarks, thermochromic inks, and combinations thereof.

Preferred additional authentication components are field-readable or consumer-obvious authentication components, as the inventive merchandising component desirably requires little or no training in order to be utilized to definitively authenticate a product. Preferably, any additional authentication component will be a field-readable authentication component. In certain preferred embodiments, any additional authentication components will desirably include a chemical or biological taggant, or a combination of such taggants, including, e.g., UV inks, photosensitive inks, colored microparticle taggants, stokes phosphors, anti-stokes phosphors, X-ray fluorescent taggants , rf-active taggants, and combinations thereof. Of these, anti-stokes phosphors, which are also known as upconverting phosphors, are particularly preferred in those embodiments in which additional authentication components are desirably utilized in the merchandising component.

Upconverting phosphors are materials that emit light at a shorter wavelength (i.e., higher energy) relative to that of the source of incident light. Upconverting phosphors can be contrasted with stokes phosphors, which are also known as downconverting phosphors, that emit light at higher wavelengths, corresponding to lower energy, relative to the excitation source. Upconverting phosphors are uncommon, and more difficult to manufacture than downconverting phosphors, and as such, may be more useful in authentication or security applications.

Any upconverting phosphor may be advantageously employed as the at least one other authentication component in the merchandising component. Typically, these materials are ceramics based upon yttrium, oxides, fluorides, oxysulfides, oxychlorides, ytterbium, and lanthanum and can further be doped with erbium, ytterbium, lanthanum or any other desired dopant. Useful chemical compositions of upconverting phosphors include, e.g., Y₂O₂S:Er, Y₂O₂S:Yb, Tm, YF₃:Er,Yb, YbOCl:Er, La₂O₂S:Er, Yb, and combinations thereof. Each of these is commercially available, e.g., from Luminophor, JSC. (Stavropol, Russia).

The merchandising component is capable of being utilized to authenticate a product, and as such, may advantageously be provided in combination with a product to provide the present product and merchandising component combination. The product in such a combination may be any commercial product desirably capable of being authenticated without further limitation. In this aspect of the invention, the merchandising component may further include a packaging material, or an item capable of being connected to a product, so that the authentication component thereof can be physically associated with the product.

The merchandising component can include, e.g., packaging materials such as film, paper, molded plastic, cardboard, boxing, envelopes, any packaging material capable of at least partially surrounding the product to be authenticated, and combinations thereof. Useful packaging materials include, e.g., film (e.g., shrink-wrap film), molded plastic, boxing, tamper-evident or resistant seals, tapes or bands, and combinations thereof. Many such materials are known and are commercially available, and any of these may be utilized as a packaging material, if a packaging material is desired. Examples of suitable shrink-wrap films include polyvinyl chloride (PVC), polyolefin, oriented polypropylene (OPP) including, e.g., monoaxially oriented polypropylene (MOPP) and biaxially oriented polypropylene (BOPP), and combinations thereof. Tamper-evident seals and tapes can be easily manufactured via a variety of lamination processes, and are commercially available from a number of manufacturers including, e.g., Surelok Company (Calcutta, India) and Minnesota Mining and Manufacturing Company (Maplewood, Minn.).

The merchandising component can further include any item capable of being connected to a product including, e.g., hang tags, labels, films, hang tabs (i.e., articles capable of supporting a product in a hanging fashion), and combinations thereof. If the merchandising component includes such an item, the item may be attached to the product itself, to any packaging further associated with the product, or a combination thereof.

Inasmuch as the combination of a product with a merchandising component provides the opportunity to easily and readily determine the authenticity of a product, the present invention further provides methods of associating a product with such a merchandising component. As before, the product to which the method may be applied is not limited, and any product may be selected and utilized in the method. Once the product has been selected, a two-dimensional image with which to determine the authenticity of the product is selected and is desirably verbally describable in an objective manner, such as an ‘x’ image. A merchandising component that includes an authentication component capable of producing the image is then provided and operatively disposed relative to the product.

More specifically, and as discussed above, methods of producing the preferred authentication component, which include a light shaping diffuser, are known, and any of these may be utilized to provide the authentication component. Similarly, methods of producing other authentication components are also known and any of these may be utilized to provide further authentication components in connection with the merchandising component. Further, if the merchandising component includes packaging material or a connectable item, any of the many well known methods of manufacturing such things can be utilized to prepare such a merchandising component.

Certain of the packaging materials that may be included in the merchandising component can provide additional security against attempted replication of the authentication component or tampering with the product of the combination. For example, in that embodiment in which the merchandising component includes packaging material in the form of a shrink wrap film, the authentication component can be provided in connection with the film prior to shrinkage in a compensatory fashion so that the authentication component will produce the desired image once the film has been shrunk about at least a portion of a product or its packaging. Alternatively, the authentication component may be provided on a shrinkable material that is also tamper-resistant or tamper-evident. That is, (and in addition to the enhanced security provided by applying the authentication component in a compensatory fashion) the tamper-evident or resistant material can be provided so that attempted removal of the authentication component will result in its destruction, will reveal tamper-evident indicia, or both.

The merchandising component can be utilized to authenticate any desired article according to the method provided. In particular, a product may be authenticated by operatively disposing a merchandising component relative to the product, the merchandising component including an authentication component capable of producing a human readable image upon irradiation with electromagnetic radiation. The authentication component is irradiated and the resulting image inspected in order to reach an authentication determination.

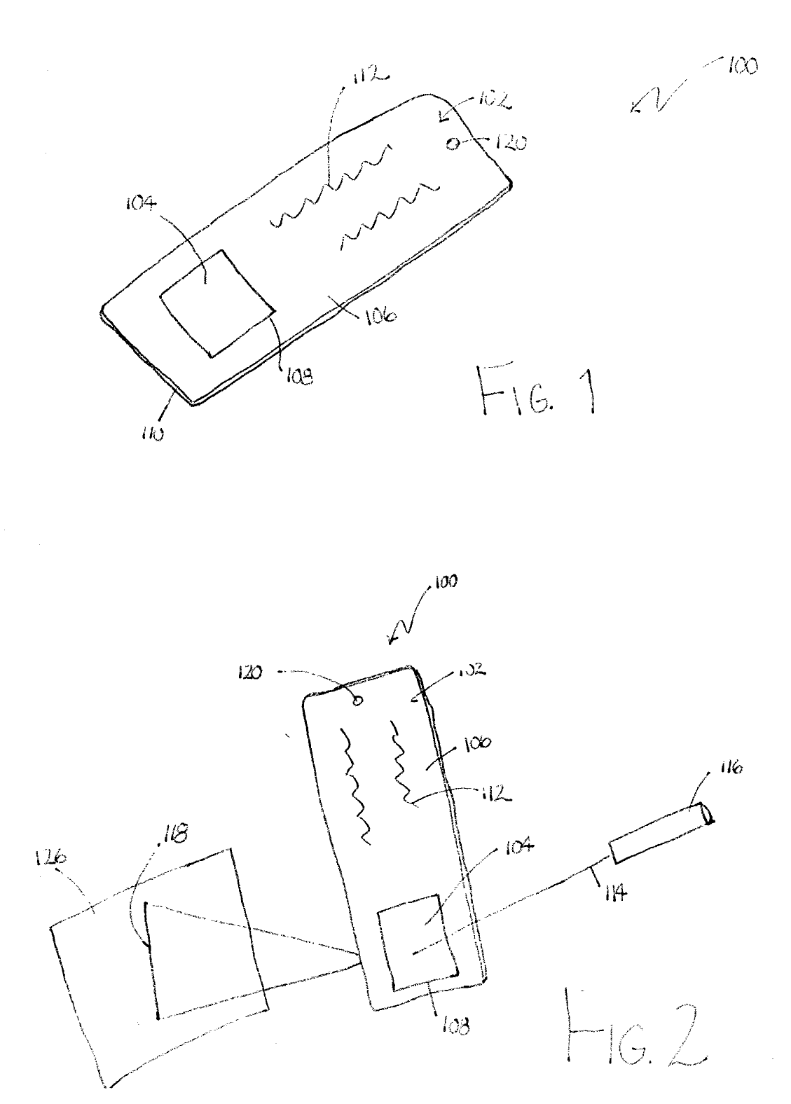

Referring now to FIGS. 1 and 2, there is illustrated a merchandising component 100 that includes an authentication component 104 and a connectable item 102. The connectable item 102 includes a supporting substrate 106, an opening 108 within the substrate 106 and hole 120 extending through the substrate 106. The hole 120 can be used to connect the merchandising component 100 to a product via any connector. The authentication component 104 is operatively disposed relative to the opening 108 so that an incident light beam (not shown) may pass through the opening 108 and the authentication component 104.

The authentication component 104 can be so disposed by any known method, and the particular method utilized is not critical provided that an incident light beam could pass through at least a portion of the authentication component 104 if transmissive, or reflect off of the authentication component 104 if reflective. The authentication component 104 can be maintained in position on the substrate 106 using any suitable means including, e.g., mechanical means, adhesive means, and combinations thereof. For example, the authentication component 104 can be affixed to supporting substrate 106 via adhesive. Alternatively, the authentication component 104 can be held in place via lamination of two opposing surfaces forming the supporting substrate 106.

Although the supporting substrate 106 is shown having an opening 108 provided therein, this configuration is not required. The authentication component 104 can be provided in connection with the supporting substrate 106 in any configuration that would allow an incident beam of light to encounter at least a portion of the authentication component 104. For example, the authentication component 104 can be adhered to an end 110 of the supporting substrate 106 such that at least a portion of the authentication component 104 extends beyond the end 10 of the supporting structure 106. Alternatively, the supporting structure 106 can include a notch (not shown) in any edge of the supporting structure 106 and the authentication component 104 can be operatively disposed relative thereto.

The supporting structure 106 can be made of any desired material including, e.g., paper, plastic, metal, cardboard, or a combination thereof, and may optionally include identifying indicia 112 including, e.g., indicia indicative of brand, origin, or any other information related to a product to which connectable item 102 may be connected.

Referring now to FIG. 2, the method of using merchandising component 100 to authenticate a product is illustrated. The merchandising component 100 is operatively disposed relative to a product (not shown) to be authenticated. An incident beam 114 of electromagnetic radiation from source 116 contacts the authentication component 104. The authentication component 104 transmits and shapes the incident beam 114 into an image 118 on a surface 126. The image 118, which is verbally describable in an objective manner as a line, may then be compared with a description of the authentication image known to be associated with an authentic product and a definitive authenticity determination made. In this particular example, if authentic products were associated with a line image, the product (not shown) associated with merchandising component 100 would be identified as authentic. If any other image was associated with authentic products, the product (not shown) associated with the merchandising component would be identified as counterfeit.

The source 116 of radiation may be any source capable of emitting electromagnetic radiation in the UV, visible, and/or near IR regions of the electromagnetic spectrum, i.e., radiation having a wavelength between 365 nm and 1600 nm. Generally speaking, the particular wavelength of radiation produced in this range is not critical. However, in those embodiments in which the merchandising component includes a number of authentication components and one of these is wavelength dependent, it is necessary to utilize the indicated wavelength in order to utilize that particular authentication component of the merchandising component.

Further, although the source 116 is illustrated as being spaced a distance apart from the merchandising component 100 and the merchandising component 100, in turn, is shown as being spaced a distance apart from surface 126, these distances are not critical, and are not intended to indicate any particular scale. Furthermore, although a separate surface 126 is shown, a separate surface for viewing image 118 may not always be required. That is, there may be some product and merchandising component combinations that would allow image 118 to be viewed on the product, or some portion of the product's packaging.

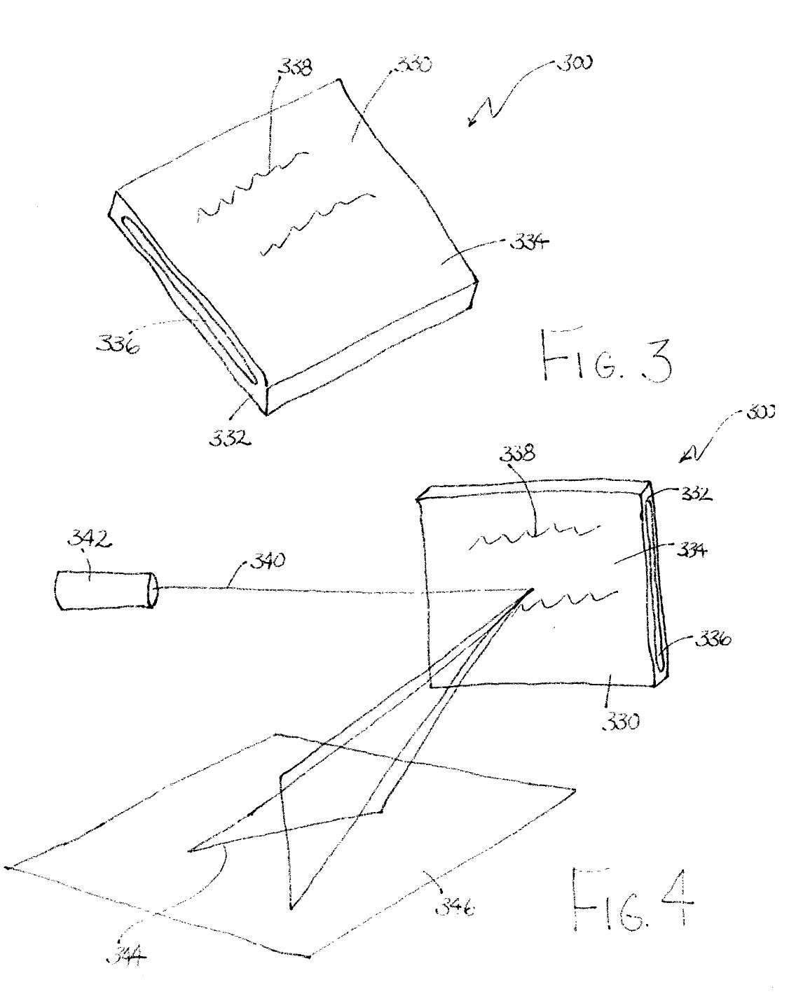

Referring now to FIGS. 3-10, other embodiments of product and merchandising component combinations are illustrated. Attributes of FIGS. 3-10 similar to those already described in connection with FIGS. 1-2 will not be described further in connection with FIGS. 3-10.

Referring to FIG. 3, there is shown a product and merchandising component combination 300 that includes product 330 and merchandising component 332. The merchandising component 332 includes an authentication component (not visible in this view) in the form of an LSD holographically recorded onto a film 334, that partially surrounds the product 330 and includes openings 336 at the ends thereof. The LSD was previously recorded onto the film 334, which was subsequently formed into a tube. The tube of film 334 was then shrunk about the product 330.

Identifying indicia 338 can be provided in connection with the product 330 the film 334 or a combination thereof. Although the product 330 is shown as generally having the configuration of a jewel case for, e.g., a CD or DVD, the product 330 can be any product. Furthermore, although merchandising component 332 is shown as further including packaging in the form of a shrink wrap film, the merchandising component 332 can include any desired packaging including, e.g., a non-shrinking film.

The merchandising component 332 is capable of authenticating a product 330 as shown in FIG. 4. More specifically, the product 330 could either be or be caused to be metallic, or could be provided with a metallic patch or label (not shown). An incident beam 340 of electromagnetic radiation from a source 342 contacts the film 334, which has an authentication component recorded thereon (not shown). The authentication component (not shown) shapes the incident beam 340, which is then reflected by metallic or metallized product 330. The reflected image 344, which is objectively verbally describable as an ‘x’, can be viewed on surface 346. The product 330 can then be authenticated by comparing the reflected image 344 with an authentication image known to be associated with the product 330.

The LSD may be compensatorily recorded, so that the image produced by the LSD has a desired aspect ratio after shrinkage, or, may be recorded with a desired aspect ratio prior to shrinkage and then allowed to shrink with the film. If the authentication component (not shown) is recorded on the film 334 prior to shrinkage, it could advantageously be harder to reproduce than an authentication component not compensatorily recorded on a shrink wrap film.

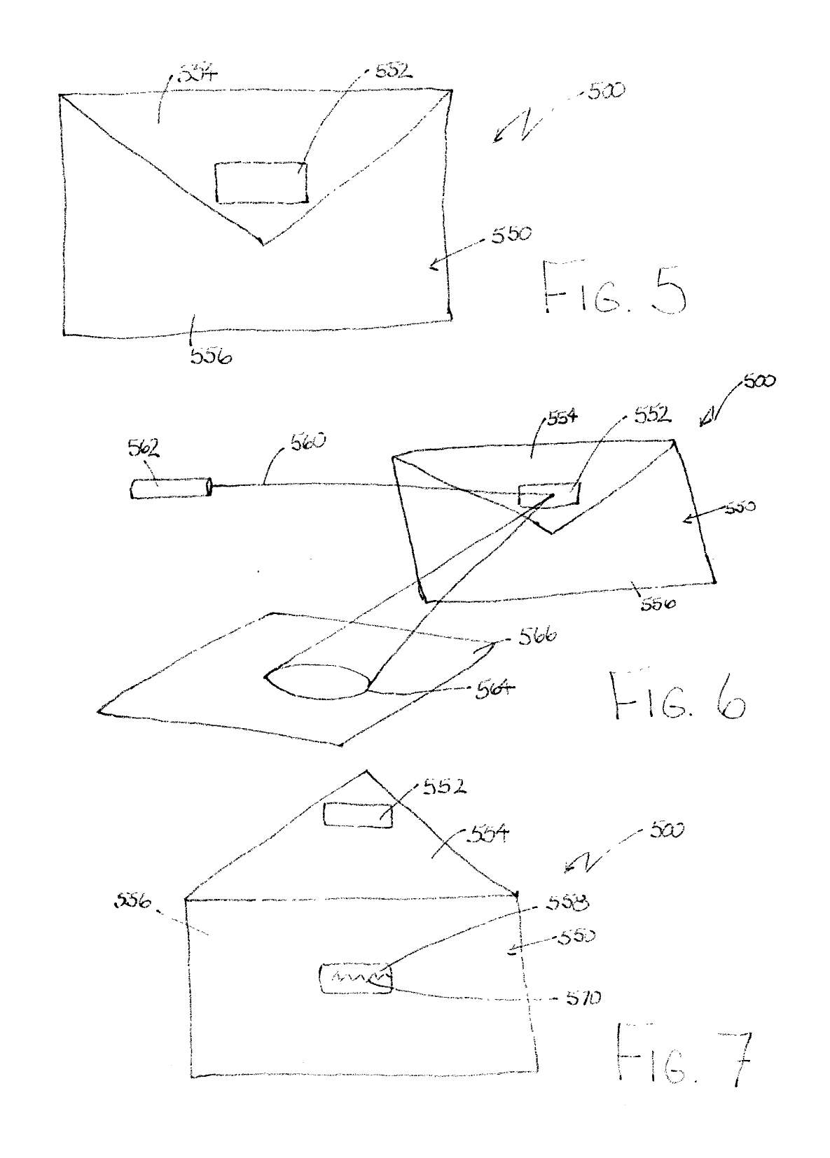

Referring now to FIGS. 5-7, there is illustrated a further embodiment of a product and merchandising component combination, as well as the utilization of the merchandising component to authenticate the product and/or to indicate any attempted tampering with the product. Referring in particular to FIG. 5, there is shown product and merchandising component combination 500 that includes a product (not shown) and merchandising component 550. The merchandising component 550 includes packaging in the form of a metallized tamper-evident seal 552 operatively disposed relative to a closure 554 of an envelope 556, which may enclose a product (not shown) such as documents or articles to be authenticated. The authentication component (not shown) is holographically recorded onto a metallized tamper-evident seal 552. The merchandising component 550 is thus capable of authenticating the product (not shown) as shown in FIG. 6.

As shown, incident beam 560 of electromagnetic radiation from source 562 contacts a metallized tamper-evident seal 552, which includes an authentication component (not shown). The metallized tamper-evident seal 552 and the authentication component (not shown) that is recorded in the seal reflect and shape, respectively, incident beam 560. The reflected image 564, objectively verbally describable as a circle, can be viewed upon surface 566. The product (not shown) may be authenticated by comparing the reflected image 564 with an authentication image known to be associated with product enclosed within envelope 556.

FIG. 7 illustrates the ability of merchandising component 550 to indicate potential tampering with the product. Metallized tamper-evident seal 552 is adhered over non-LSD film 558 with a low tear adhesive (not shown). Non-LSD film 558 has verbiage or other indicia 570 provided thereon indicating any attempted removal of the overlying film, such as the words “opened,” “void,” or a stop symbol. When the metallized tamper-evident seal 552 is present, as shown in FIGS. 5 and 6, non-LSD film 558 and accompanying indicia 570 are not visible. However, and as is shown by FIG. 7, if the metallized tamper-evident seal 552 is removed, the non-LSD film 558 and indicia 570 become visible, thereby alerting a consumer to potential tampering activity in connection with the product.

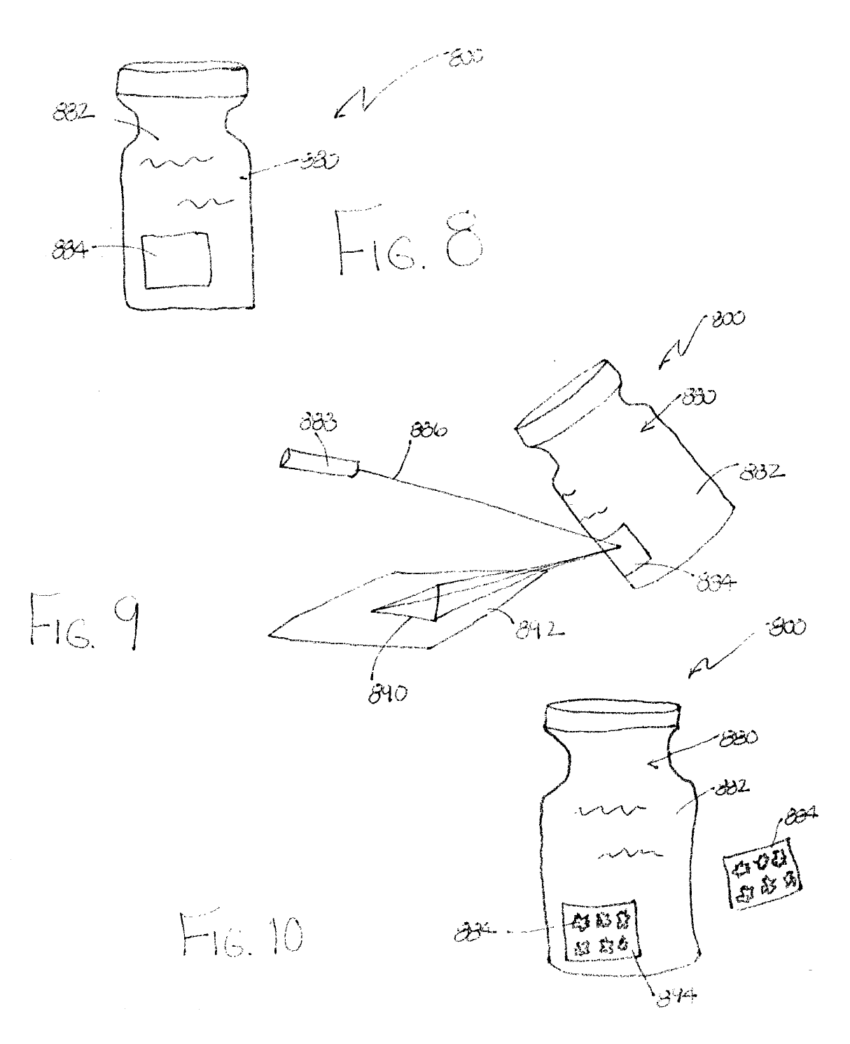

FIGS. 8-10 illustrate a further embodiment of a product and merchandising component combination, as well as the utilization of the merchandising component to authenticate the product and/or to indicate any attempted tampering with the authentication component.

Referring in particular to FIG. 8, there is shown a product and merchandising component combination 800 that includes a product (not shown) and a merchandising component 880.

The merchandising component 880 includes packaging in the form of a bottle 882, as well as a connectable item in the form of metallized tamper-resistant label 884. The authentication component (not shown) is holographically recorded onto a metallized tamper-resistant label 884. Although described in connection with FIG. 8 as being metallized, the tamper-resistant label 884 need not be metallized if the bottle 882 is reflective, or if the tamper-resistant label 884 is provided overlying a reflective substance as may be provided in connection with bottle 882.

Merchandising component 880 is capable of authenticating a product as shown in FIG. 9. As shown, incident beam 886 of electromagnetic radiation from source 888 contacts metallized tamper-resistant label 884, which includes an authentication component (not shown). The metallized tamper-resistant label 884 and the authentication component (not shown) recorded thereon reflect and shape, respectively, the incident beam 886. The reflected image 890, objectively verbally describable as a triangle, can be viewed upon surface 892. Product (not shown) can then be authenticated by comparing the reflected image 890 with an authentication image known to be associated with the product enclosed within the bottle 882.

FIG. 10 illustrates the ability of the merchandising component 880 to indicate attempted counterfeiting of an authentication component present on a metallized tamper-resistant label 884, tampering with the product, or both. The metallized tamper-resistant label 884 can be provided as a relatively thinner film with relatively low tensile and tear strengths. The metallized tamper-resistant label 884 is then laminated to relatively thicker film 894 having relatively higher tensile and tear strengths using an adhesive (not shown) having a relatively high peel strength that has been applied in a periodic pattern. The laminated metallized tamper-resistant label 884 is adhered to a bottle 882 with an adhesive (not shown) having a relatively higher peel strength than the adhesive used in laminated metallized tamper-resistant label 884. If an attempt is made to remove the laminated metallized tamper-resistant label 884, the relatively thinner film of the LSD will remain bonded to the relatively thicker film of the laminate in the area of the periodic pattern of the adhesive, but will tear away (i.e., can be separated) from the relatively thicker film in the area in which the LSD film it is not bonded to the relatively thicker film through an adhesive. As a result, and as shown, if removal of tamper-resistant label 884 is attempted, the thin LSD film would be destroyed, since the uneven application of the adhesive would cause the LSD film to tear where adhered to the thicker non-LSD film.

### EXAMPLE 1

### 1) Preparation of a Product and Merchandising Component Combination in which the Merchandising Component Includes a Number of Authentication Components and a Connectable Item

The LSD film 95×35PE5-2, capable of producing an ellipse upon irradiation, will be purchased from Physical Optics Corporation (Torrence, Calif.). The upconverting phosphor FCD-660-4, capable of emitting red light upon irradiation with a beam of light having a wavelength of 980 nm, will be purchased from Luminophor JSC (Stavropol, Russia). Aluminum will be deposited upon the LSD film via chemical vapor deposition using appropriate parameters. The film will then be cut to a desired size and affixed to a connectable item, e.g., a hang tag, in any fashion. The upconverting phosphor will be mixed with any available varnish and applied to the connectable item in an area separate from the LSD, that will allow reflected light from the LSD to be incident thereupon. The hang tag will then be connected to the desired product using any suitable means including, e.g., by a plastic connector, plastic ring, string, or pin.

### 2) Authentication of the Product Using the Merchandising Component

The product may thereafter be authenticated utilizing the hang tag of this example by irradiating the metallized LSD authentication component with infrared energy at a wavelength of 980 nm, as may be provided by a UCP-980-10 radiation source, which is commercially available, e.g., from Roithner Lasertechnik (Vienna, Austria). The reflected light beam can be viewed upon the surface coated with the up-converting phosphor. Although the incident light beam is infra-red and thus not visible prior viewing on the coated surface, the up-converting phosphor converts the 980 nm light, shaped via reflection from the LSD, to visible red light. The presence of the upconverting phosphor provides one level of authentication to the product to which the tag is attached, i.e., the viewed shape must be red. The LSD will act to shape the emitted beam to the form of an ellipse, thereby providing a second level of authentication to the product.

It is expected that since the hang tag so prepared includes both an LSD and an upconverting phosphor, the tag will be more difficult to counterfeit than a tag not including such a combination. As a result, the product to which the tag is attached may also be more secure against counterfeiting attempts. Further, this example illustrates an embodiment of the invention in which a separate surface for viewing the image reflected by the LSD is not required. Rather, the image reflected is conveniently viewed on the merchandising component itself.

### EXAMPLE 2

### 1) Preparation of a Product and Merchandising Component Combination that Includes Packaging Material

An LSD will be holographically recorded onto oriented polypropylene that will subsequently be shrunk 20% in the minor axis in order to tighten it about a product to be authenticated according to known holographic recordation techniques. In order to maintain the light shaping performance of the LSD so that it will produce an emitted beam having an oval pattern with a 4:1 aspect ratio once the film has been shrunk, the recordation of the LSD will be distorted, and it will be recorded in a fashion so that it would produce an emitted beam having an oval pattern with a 3.2:1 aspect ratio prior to shrinkage of the film. The film will then be formed into a tube, which will then be caused to shrink about at least a portion of a product to be authenticated. If the product to be authenticated with the wrap is not already reflective, a reflective layer or patch will be attached to at least a portion of a surface of the product that will be operatively disposed relative to the shrink wrap prior to its shrinkage about the product.

### 2) Authentication of a Product Using the Merchandising Component

The product may be authenticated by irradiating the LSD film with electromagnetic radiation whereby the reflected emitted beam, when viewed on a surface operatively disposed relative to the film and reflective layer, will have an oval pattern with a 4:1 aspect ratio.

It is expected that since the LSD is provided on a shrink-wrap film, it will be more difficult to counterfeit than an LSD provided on non-shrinking film. As a result, a product wrapped in such a film may also be more secure against counterfeiting attempts.

### EXAMPLE 3

### 1) Preparation of a Product Merchandising Component Combination that Includes a Connectable Item and the Authentication Component is Provided as a Portion of a Tamper-Resistant Laminate

A laminate construction will be prepared by holographically recording an LSD onto a thin film having relatively low tensile and tear strengths. This LSD film will then be laminated to a relatively thicker non-LSD film having relatively higher tensile and tear strengths using an adhesive having a relatively high peel strength that has been applied in a periodic pattern. The resulting laminated LSD construction will be adhered to the product to be authenticated with an adhesive having a relatively higher peel strength than the adhesive used in the laminate construction. As such, any attempts to remove the LSD label in order to replicate it would result in the destruction of the thin LSD film, since the uneven application of the adhesive would cause the LSD film to tear where adhered to the thicker non-LSD film, as described above.

### 2) Authentication of a Product Using the Merchandising Component

If applied over a radiation transparent portion of the product, the label could simply be irradiated, the transmitted beam viewed and an authentication determination made. If there is no radiation transparent portion of the product, and the product itself is reflective, the label could also be irradiated and the reflected beam viewed and an authentication determination made. Otherwise, the label may be rendered reflective via lamination to a reflective material or deposition of a reflective material on either the LSD or non-LSD film layer or the product may be rendered reflective via application of a reflective label or portion operatively disposed relative to the LSD laminated label. In any of these, the authentication of the product would be determined by viewing the reflected beam.

It is believed that the lamination of an LSD film to at least one other higher strength film in this fashion to form a tamper-resistant label will render the LSD more difficult to replicate, since the LSD would not be able to be removed for analysis without destroying the LSD. As such, this embodiment of the inventive merchandising component may provide more robust counterfeit protection than that provided by an LSD not laminated in such a fashion.

### EXAMPLE 4

### 1) Preparation of Product and Merchandising Component Combination in which the Component is Provided as a Portion of a Tamper-Evident Seal

An LSD will be holographically recorded onto a relatively thinner metallized film with low tensile and tear strength. This LSD film will then be laminated onto an upper surface of a relatively thicker non-LSD film having relatively high tensile and tear strengths using an adhesive having a relatively low peel strength. The non-LSD film will further be printed with text indicating the removal of the LSD film, such as “OPENED” or “VOID”, which text will not be visible through the overlying metallic LSD film. The resulting laminated LSD seal will be adhered to the product to be authenticated with an adhesive having a relatively higher peel strength than that used in the laminate.

### 2) Authentication of a Product using the Merchandising Component

The metallized LSD portion of the laminated seal, when illuminated, will reflect a beam that can be viewed in order to make an authentication determination with respect to the product. If the LSD portion is removed, the printing on the non-LSD film will become visible, so that although the LSD will not be present to be used to authenticate the product, the product itself will provide evidence that tampering has occurred.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A merchandising component for authenticating a product comprising an authentication component capable of producing a human readable image upon irradiation with electromagnetic radiation, the image capable of being verbally described in an objective manner, wherein the merchandising component is capable of being used to authenticate a product by comparing the human readable image produced by the authentication component thereof with an authentication image associated with the product.

2. The merchandising component of claim 1, wherein the authentication component comprises a light shaping diffuser.

3. The merchandising component of claim 1, comprising a plurality of authentication components.

4. The merchandising component of claim 3, comprising at least two light shaping diffusers.

5. The merchandising component of claim 3, wherein at least one of the plurality of authentication components is different from the other authentication components.

6. The merchandising component of claim 5, wherein at least one of the plurality of authentication components comprises a field readable authentication component.

7. The merchandising component of claim 6, wherein the field readable authentication component comprises a chemical or biological taggant.

8. The merchandising component of claim 7, wherein the taggant is a phosphor.

9. The merchandising component of claim 8, wherein the phosphor is an upconverting phosphor.

10. The merchandising component of claim 5, wherein at least one of the plurality of authentication components comprises a consumer-obvious authentication component.

11. The merchandising component of claim 10, wherein the consumer-obvious authentication component comprises a hologram or a watermark.

12. A product and merchandising component combination, the product having an authentication image associated therewith, the merchandising component comprising an authentication component capable of producing a human readable image upon irradiation with electromagnetic radiation, the image capable of being verbally described in an objective manner, wherein the authenticity of the product can be determined by comparing the human readable image with the authentication image associated with the product.

13. The combination of claim 12, wherein the merchandising component comprises packaging material at least partially surrounding the product.

14. The combination of claim 13, wherein the packaging material is wrapped about at least a portion of the product.

15. The combination of claim 14, wherein the packaging material comprises a film.

16. The combination of claim 15, wherein the packaging material comprises a shrink-wrap film.

17. The combination of claim 14, wherein the packaging material comprises molded plastic.

18. The combination of claim 13, wherein the packaging material comprises a box.

19. The combination of claim 14, wherein the packaging material comprises a tamper-evident or tamper-resistant article.

20. The combination of claim 19, wherein the article comprises a band, seal or tape.

21. The combination of claim 12, wherein the merchandising component comprises an item capable of being connected to the product.

22. The combination of claim 21, wherein the merchandising component comprises a hang tag.

23. The combination of claim 21, wherein the merchandising component comprises a hang tab.

24. The combination of claim 21, wherein the merchandising component comprises a label.

25. The combination of claim 24, wherein the label is attached to at least one of the product and a package at least partially surrounding the product.

26. The combination of claim 12, wherein the authentication component comprises a light shaping diffuser.

27. The combination of claim 12, comprising a plurality of authentication components.

28. The combination of claim 27, comprising at least two light shaping diffusers.

29. The combination of claim 27, wherein at least one of the plurality of authentication components is different from the other authentication components.

30. A method of associating a product with an authentication component comprising:
providing a product;
selecting an image to identify the product as authentic, the image capable of being verbally described in an objective manner;
providing a merchandising component comprising an authentication component capable of producing the image in a human readable fashion upon irradiation with electromagnetic radiation; and
operatively disposing the merchandising component relative to the product.

31. The method of claim 30, wherein the merchandising component comprises packaging material.

32. The method of claim 31, wherein the merchandising component comprises a shrink-wrap film.

33. The method of claim 32, wherein the authentication component is provided over at least a portion of the shrink wrap film prior to shrinkage of the film and wherein the step of operatively disposing the merchandising component comprises causing the shrink wrap and the authentication component to shrink so as to enclose at least a portion of the product or a package at least partially enclosing the product, whereby the shrunken authentication component produces the image upon irradiation.

34. The method of claim 33, wherein at least a portion of the verbal description of the image comprises the aspect ratio of the image produced.

35. The method of claim 31, wherein the merchandising component comprises a tamper-resistant or tamper-evident article.

36. The method of claim 35, wherein the article comprises a seal, band or tape.

37. A method of authenticating a product comprising
(a) operatively disposing a merchandising component relative to the product, the merchandising component comprising an authentication component capable of producing a human readable image upon irradiation with electromagnetic radiation, the image capable of being verbally described in an objective manner;
(b) irradiating the authentication component with electromagnetic radiation;
(c) visually inspecting the image produced; and
(d) determining the authenticity of the product.

38. The method of claim 37, further comprising providing an objective verbal description of an authentication image associated with the product.

39. The method of claim 37, wherein the image produced is viewed upon a surface separate from the product and a package enclosing at least a portion of the product.

40. The method of claim 37, wherein the image produced is viewed upon at least a portion of the product, a package enclosing at least a portion of the product, or both.
